(19) United States
(12) Patent Application Publication
(10) Pub. No.: US 2006/0102615 A1
(43) Pub. Date: May 18, 2006

(54) Thermal Protection Blanket

(76) Inventor: Martin Carriere, Calgary (CA)

Correspondence Address: STEPHEN J. LEWELLYN, 933 OLEANDER WAY SOUTH, SUITE 3, SOUTH PASADENA, FL, 33707, US

(21) Appl. No.: 10/904,611

(22) Filed: Nov. 18, 2004

(51) Int. Cl. H05B 3/34

(52) U.S. Cl. 219/528

(57) ABSTRACT

A thermal protection blanket for protecting processing equipment subjected to freezing temperatures is provided. The thermal protection blanket includes a flexible covering that is conformable to a numerous number of differently structured processing equipment with out requiring reconfiguration of the blanket. A self regulating heating element is provided to heat the processing equipment to prevent freezing and failure. The design of thermal protection blanket meets the requirements to be used in hazardous conditions, such as those found in the petroleum industry as well as general processing equipment heating use. The thermal blanket is constructed from a material that has repellant proprieties, is weather resistant, is resistant to tearing and is able to withstand extreme temperate ranges from −50 degrees Fahrenheit to 500 degrees Fahrenheit. Additionally, standard electrical connections are provide to eliminate the requirement of an electrician to install the blanket.

### FIELD OF THE INVENTION

The present invention relates generally to heating process equipment subjected to extended periods of freezing temperatures. More particularly, relating to a flexible and readily removable blanket for enclosing and heating processing equipment, such as those typically used in oil production.

### BACKGROUND OF THE INVENTION

Oil field processing equipment, such and by way of example blow out preventers (BOP), piping, valves, platform supply vessels and wellheads, are subjected to extended periods of extreme temperatures which reach below −40 degree F. During these periods, the processing equipment will freeze off and fail if they not protected. Typically to protect the process equipment, the equipment is covered and heated in some fashion.

One method involves covering the equipment with heat tape, insulation and aluminum cladding. While this method works well to maintain the process equipment at an operating temperature and to prevent freezing, it is not cost effective. Servicing the equipment requires the removal of the aluminum cladding, insulation and heat tape. Quite often, the work crew damages the aluminum cladding, insulation or heat tape during the removal, thus requiring replacement of the damaged components to put the equipment back into service. Additionally with this method, an electrician is required to facilitate connecting the heat tape to an electrical source.

The prior art has recognized the pitfalls of the above-described method and has attempted to provided an apparatus to overcome the deficiencies. One such apparatus is described in U.S. Pat. No. 5,049,724, which is incorporated herein in entirety by reference. This apparatus provides for a form fitted, removable cover for covering and heating a single piece of process equipment, such as a BOP. The covering is designed and constructed to meet the specific structure of the equipment it is intended to cover and can not be used to cover additional equipment that have a structure which differs from the original design. Therefore, multiple, custom designed covers are needed to protect several different process equipment that are used, this tends to be a costly and non-versatile method.

### SUMMARY OF THE INVENTION

In accordance with the present invention, an apparatus for enclosing and heating processing equipment is provided.

In one aspect, a thermal protection blanket is provided having a flexible cover with a continuous outer surface and a continuous inner surface, a self regulating electrical heating element which is detachably secured to the inner surface, a pair of mating fasteners are attached to the inner surface along the perimeter, and an electrical power source detachably connected to the self regulating electric heating element. The flexible cover is foldable along a mid section and about the processing equipment to bring one half of the inner surface of the flexible cover about the second half of the inner surface of the flexible cover. the first and second halves are sealed along their common edges by the pair of mating fasteners to create an envelope enclosing the process equipment. A fastening means is included for tightening the envelope about the processing equipment to maintain the heat within the envelope.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a view illustrating the outer surface of a thermal protection blanket spread open and constructed in accordance with the principles of the present invention;

FIG. 2 is a view illustrating the inner surface of the thermal protection blanket spread open; and

FIG. 3 is a front elevation of the thermal protection blanket in a folded position, non-cinched configuration.

The same reference numerals refer to the same parts throughout the various figures.

### DETAILED DESCRIPTION OF THE INVENTION

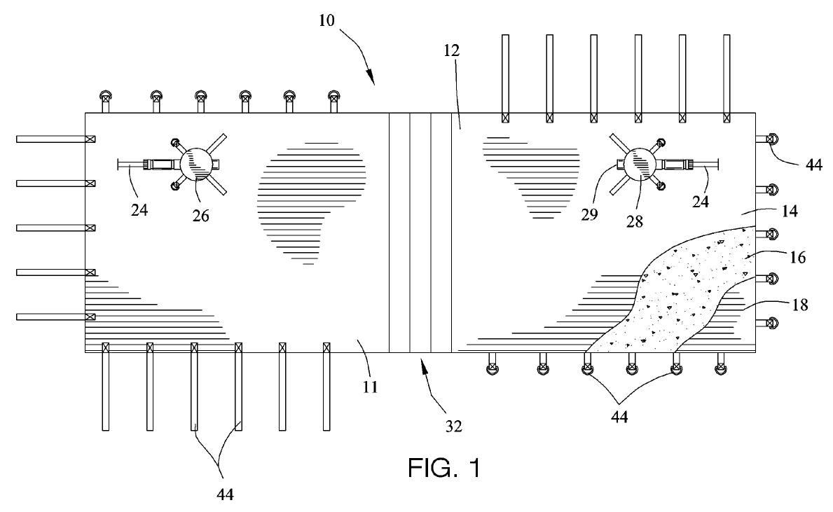

Referring now to the drawings, and particularly to FIGS. 1-3, a preferred embodiment of the thermal protection blanket of the present invention is shown and generally designated by the reference numeral 10.

In FIG. 1, the thermal protection blanket 10 is shown laid open to illustrate the external surface 11. The thermal protection blanket is used to cover and protect processing equipment located in environments that are subjected to extremely low temperatures by providing a heated enclosure to maintain the processing equipment at a desired temperature to prevent freezing and failure.

The thermal protection blanket 10 includes a flexible covering 12 constructed of an outer layer 14, an intermediate layer 16 of an insulating material, and an inner layer 18. The outer layer 14 and inner layer 18 are attached to one another using known methods to encase the intermediate layer 16. The intermediate layer 16 is of a flexible material having high insulating properties, that is non-flammable and non-corrosive. The outer layer 14 and the inner layer 18 is of a material that has repellant proprieties, is weather resistant, is resistant to tearing and is able to withstand extreme temperate ranges from −50 degrees Fahrenheit to 500 degrees Fahrenheit One such material is silicone coated fiberglass cloth, which is readily available from many different manufactures.

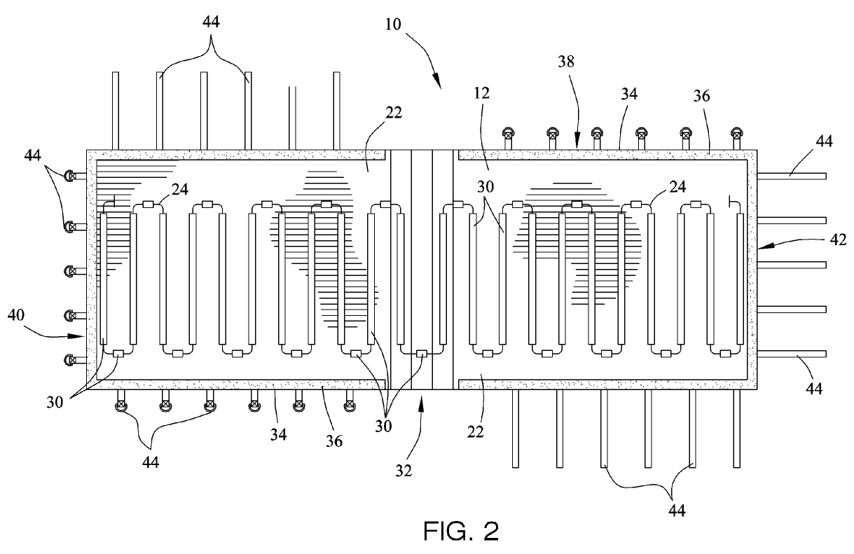

Referring now to FIG. 2, which shows thermal protection blanket 10 laid open to illustrate the internal surface 22. The thermal protection blanket 10 is fitted with a self regulating heating cable 24. The self regulating heating cable 24 is rated to be used in hazardous locations, such as those found in the petroleum industry as well as for general purpose areas making the thermal protection blanket 10 usable in many different applications in a broad spectrum of industries.

With reference back to FIG. 1, the self regulating heating cable 24 terminates in explosion proof connector assemblies 26 and 28. The connector assemblies 26 and 28 are constructed in accordance with Canadian Electrical Code as well as the United States Electrical Code. The rating of the self regulated heating cable 24 in combination with the explosion proof connector assemblies 26 and 28 makes the thermal protection blanket 10 rated for use in Class 1, Division 1 and Zone 1 applications.

The connector assembly 26 is a end terminal for the self regulating heating cable 24 and the connector assembly 28 provides for an electrical connection 29 to the heating to cable. The electrical connection is of a standard 120 volt or 240 volt type connection to eliminate the need of an electrician to install the thermal protection blanket 10 onsite.

The self regulating heating cable 24 is removably attached to the internal surface 22 and is formed into a serpentine pattern to maximize the heat distribution within the covering 12. By using a removable attachment method the self regulating heating cable 24 can be easily replaced on location incase of failure.

The self regulating heating cable 24 can be secured to the inner surface 22 through the use of a plurality of tunnels 30 which are strategically attached to the covering and in which the self regulating heating cable is threaded through to form a serpentine pattern. Additionally, the tunnels 30 serve as a protective covering to the self regulating heating cable 24. The tunnels 30 are ideally formed from the same material used for the outer and inner layers 14 and 18.

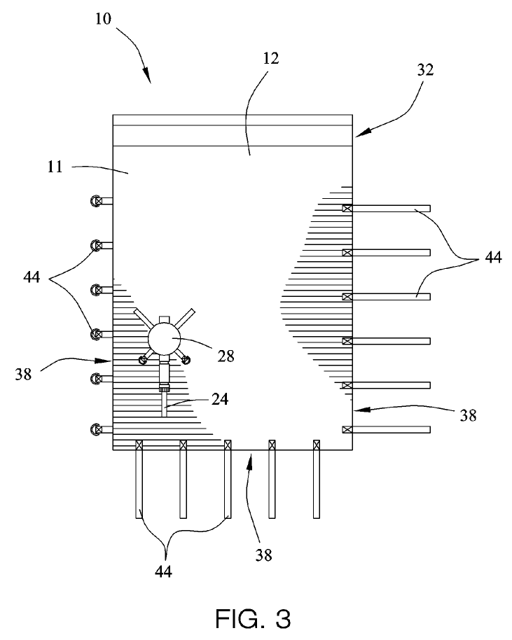

The covering 12 is designed to be folded along a mid-section 32 and about a piece of processing equipment to create an bag-like or envelope enclosure which encases the processing equipment, as illustrated in FIG. 3. The perimeter 34 of the inner surface 22 is fitted with a mating fastener 36, such as a hook and loop type fastener. The mating fastener 36 can be of a continuous strip of hook and loop material or can be discrete portions of hook and loop material. Additionally, a plurality of snap type fasteners or the like arranged around the perimeter 34 could be used in place. When the covering 12 is folded along the mid-section 32 the edge 38 of the covering along opposing sides 40 and 42 thereof are brought into contact and are sealed together by the mating fastener 36 to create the enclosure for the processing equipment.

The unique design of the covering 12 allows the covering to conform to numerous of different structured processing equipment. The manner in which the edge 38 is sealed allows the covering 12 to conform to the many different configurations of fluid inlet and outlet passages of the processing equipment to which the cover is attached. As such, the covering 12 can be easily moved from one piece of processing equipment to another with out requiring reconfiguration of the covering to conform to the specific structural orientations of the processing equipment. This makes the thermal protection blanket 10 very versatile in application and eliminates the need for the end user from purchasing many different custom formed coverings to suite the needs of the user.

Additionally, fastening straps 44 are positioned along the edge 38 and are used tighten the enclosure formed by the covering 12 around the processing equipment. FIG. 3 is illustrated without the tightened straps for clarity.

Furthermore, the mid-section 32 can be of a fanfold-type construction allowing the enclosure to expand to accommodate the width of a particular piece of processing equipment to which the thermal protection blanket 10 is attached.

A number of embodiments of the present invention have been described. Nevertheless, it will be understood that various modifications may be made without departing from the spirit and scope of the invention. Accordingly, other embodiments are within the scope of the following claims.

What is claimed is:

1. A thermal protection blanket for heating process equipment, the thermal protection blanket comprising:
a flexible cover having a continuous external surface and a continuous internal surface;
a self regulating electrical heating element detachably secured to said internal surface;
a mating fastener attached to said inner surface and along the perimeter thereof;
said flexible cover being folded along a mid section and about the processing equipment to bring one half of said inner surface of said flexible cover about the second half of said internal surface of said flexible cover, the first and second halves being sealed along their common edges by said mating fastener to create an envelope enclosing the process equipment;
a fastening means for tightening said envelope about the processing equipment; and
an electrical power source detachably connected to said self regulating electric heating element.

2. The thermal protection blanket of claim 1, wherein said flexible cover comprises:
an outer layer of flexible fabric;
an intermediate layer of flexible fiberglass insulation;
an inner layer of flexible fabric; and
wherein said outer layer of flexible fabric and said inner layer of flexible fabric are attached together to encase said intermediate layer.

3. The thermal protection blanket of claim 2, wherein said outer layer of flexible fabric and said inner layer of flexible fabric are of a silicone coated fiberglass cloth.

4. The thermal protection blanket of claim 1, wherein said flexible cover further comprising:
a fanfold mid-section.

5. The thermal protection blanket of claim 1, further comprising:
a plurality of tunnel portions attached to the inner surface of said flexible cover for receiving and holding said self regulating electrical heating element juxtaposed said inner surface.

6. The thermal protection blanket of claim 5, wherein said plurality of tunnel portions are arranged in a serpentine pattern and wherein said self regulating electrical heating element is threaded through said tunnel portions.

7. The thermal protection blanket of claim 1, further comprising explosion proof electrical connectors.

8. A thermal protection blanket for covering and heating a piece of processing equipment and which is readily conformable to the processing equipment without requiring reconfiguration, the thermal protection blanket comprising:
a flexible covering having external surface and an internal surface;
a self regulating heating element attached to said internal surface;
a mating fastener attached to said flexible covering;
said flexible covering being folded along a mid-section thereof to create an enclosure around the processing equipment and said mating fastener sealing the edge of said flexible covering to conform to the structure of the processing equipment;
fastening means for tightening said enclosure around the processing equipment; and
an electrical power source detachably connected to said self regulating electric heating element.

9. The thermal protection blanket of claim 8, wherein said self regulating heating element is a flexible heating cable.

10. The thermal protection blanket of claim 8, wherein said flexible covering comprises:
an outer layer of flexible fabric;
an intermediate layer of flexible fiberglass insulation;
an inner layer of flexible fabric; and
wherein said outer layer of flexible fabric and said inner layer of flexible fabric are attached together to encase said intermediate layer.

11. The thermal protection blanket of claim 10, wherein said outer layer of flexible fabric and said inner layer of flexible fabric are of a silicone coated fiberglass cloth.

12. The thermal protection blanket of claim 8, wherein said mid-section is of a fanfold type construction.

13. The thermal protection blanket of claim 8, wherein said mating fastener is attached to said covering along the perimeter of said inner surface.

14. The thermal protection blanket of claim 13, wherein said mating fastener is a hoop and loop fastener.

15. The thermal protection blanket of claim 8, wherein said self regulating heating element is detachable secured to said inner surface.
